(19) United States
(12) Patent Application Publication
(10) Pub. No.: US 2015/0100273 A1
(43) Pub. Date: Apr. 9, 2015

(54) AUTOMATIC VEHICLE MONITORING SYSTEM AND NAVIGATION MONITORING SYSTEM

(71) Applicants: Mehran Safdar, ISFAHAN (IR); Muhammad Mehdi Shiran, ISFAHAN (IR); Mojtaba Jamali, ISFAHAN (IR); Fatemeh Jamali, Isfahan (IR)

(72) Inventors: Mehran Safdar, ISFAHAN (IR); Muhammad Mehdi Shiran, ISFAHAN (IR); Mojtaba Jamali, ISFAHAN (IR); Fatemeh Jamali, Isfahan (IR)

(21) Appl. No.: 14/049,374

(22) Filed: Oct. 9, 2013

(51) Int. Cl. G01G 19/03

(52) U.S. Cl. CPC G01G 19/035
USPC 702/175

(57) ABSTRACT

The various embodiments herein provide an automatic vehicle load monitoring system and navigation monitoring system. The system comprises a weight sensing device attached to a base of a vehicle, and wherein the weight sensing device is a load cell, a compression spring attached to the weight sensing device and to a suspension spring of the vehicle, a voltage conversion unit attached to the weight sensing device to convert an output resistance of the load cell into a voltage, an automatic vehicle location (AVL) system connected to the voltage conversion unit to receive the output voltage from the voltage conversion unit and a central server connected to the AVL to receive a vehicle location data and a voltage data for computing a vehicle load at an instant. The vehicle location data and the vehicle load at any instant is communicated simultaneously to a driver of the vehicle.

### BACKGROUND

1. Technical Field

The embodiments herein generally relates to the weighing systems and methods for loads in the vehicles. The embodiments herein particularly relates to a portable vehicle weighing system. The embodiments herein more particularly relates to an automatic vehicle load monitoring system and navigation monitoring system.

2. Description of the Related Art

Heavy demands are made on weighing systems for use in metal processing and heavy industries because they are an important component m the process chain. It must be guaranteed that all the components work safely, accurately and reliably in a harsh operating environment.

Nowadays a large majority of freight transportation is made by road in most countries, and the volume of ground transportation is keep increasing as the result of the fast growing industry and commerce. Moreover, because of the strong competition between transport modes and companies, transportation management is improved, which has led to an increase in the numbers of fully loaded trucks and their gross weights. Recently, there have been a significant number of vehicles illegally overloaded and the damage caused by the vehicles on the road is in direct proportion to the axle weight by 4^{th} power. The overloaded transportation would greatly increase the cost for the pavement maintenance and repair, shorten the service life of pavement, even affect the traffic safety and capability. So it is imperative to build a Weigh station to solve this problem. Weight information of vehicles acquired by static weighing (i.e. does not move) was a conventional method which was used widely these days. Though the precision of this way to measure the gross weight of vehicle is very high, there are many disadvantages of the method: it is not only expensive but also not possible to measure the weight of each axle separately. The most important is that it is inconvenient to weigh with stopping vehicles in some practical application.

Recently, according to the development of the transportation system and lack of correct estimation of the weight of the load on the vehicle it has become a necessity to have a system that can measure the weight of the vehicle every moment Furthermore, a system like AVL can transfer the weight of the vehicle to central system online wherever the GPS is active.

According to the fact that the more the weight of the vehicle the more the spring is Jammed, there is a need to take use of these changes in order to estimate the weight of the vehicle.

According to the importance of electronic monitoring of the civil transportation system and due to the fact that most of the decisions of the executive managers and vehicle owners depend on the information about the location either mobile or stable. Mobility information of the vehicle is required. Meanwhile, the manner of movement itself the speed and time of movement, the traversed route, the condition of weight and fuel sensors, mobility information is required to fast and accurate decision making. That is why it is essential to design a modern system to monitor id control these vehicles for rapid decision making and lasting arrangement.

Today, in most developed countries, the mobile navigational system is used as a powerful tool to monitor and track the navigational systems of bus, taxi, police, shippers, and municipal waste collectors.

These systems are efficient in tracking the mobile vehicles and showing them on maps inside the control center. The navigational system can be an intelligent tracking net via a telegraphic, connection between mobile vehicles and control center. Therefore, monitoring the situation, exact location, speed, other information regarding each vehicle, ability to send and receive message, directing the vehicles to their destination, control on sensors (fuel, engine temperature, transferred weight via the vehicles, . . . ) in order to repair and mend based on the traversed route and to restrict the vehicles activities based on some defined rules such as forbidden areas, areas under inspection, etc. are feasible.

By putting the geographical information system together with navigational system of mobile vehicles, an information system (AVLNS) can be produced in a way that the location of the vehicles can be traced every moment on information system (Dynamic GIS). Also, analysis. AVLNS and GIS can be simultaneous.

The amount of transferred load by vehicles and calculating the value of the load has been of the concerns of the managers of transportation system. There has always been a need for a localized sensor with a reasonable price that can calculate the amount of load on the vehicle and provide it for the employer online. This sensor should come in a reasonable price, be easy to install, with high accuracy, be online,and be localized in order to meet the needs of the transportation department. The importance of such a sensor has been felt in garbage collecting. Municipality employees collect garbage from the city. These employees are paid for every kilos of garbage they collect. If they do not collect garbage, they collect bran and construction waste instead in order to make the collected garbage heavier. If the municipality is equipped with such an online sensor they would be able to know the amount of the produced garbage and exact information for metropolitan arrangements.

According to the fact that the heavy weight of the vehicle, causes the spring to become jammed, a way has been required to calculate the weight of the vehicle.

Hence there is a need for an automatic vehicle load monitoring system and navigation monitoring system that can measure the weight of the vehicle at every moment. Further, there is a need for a modern system to monitor and control the vehicles for rapid decision making and lasting arrangement. Also there is a need for a method for transferring data on the speed, location and other information regarding the vehicle.

The above mentioned shortcomings, disadvantages and problems are addressed herein and which will be understood by reading and studying the following specification.

### OBJECTS OF THE EMBODIMENTS

The primary object of the embodiments herein is to provide a portable system for measuring changes of vehicle suspension system with the help of sensors.

Another object of the embodiments herein is to provide a tracing terminal for sending and receiving of data on status of vehicle.

Yet another object of the embodiments herein is to provide a method for monitoring changes in load weight of vehicle and for calculating location and speed of the vehicle.

### SUMMARY

The various embodiments herein provide an automatic vehicle load monitoring system and navigation monitoring system. The system comprises a weight sensing device attached to a base of a vehicle, and wherein the weight sensing device is a load cell, a compression spring attached to the weight sensing device and to a suspension spring of the vehicle, a voltage conversion unit attached to the weight sensing device to convert an output resistance of the load cell into a voltage, an automatic vehicle location (AVL) system connected to the voltage conversion unit to receive the output voltage from the voltage conversion unit and a central server connected to the AVL to receive a vehicle location data and a voltage data for computing, a vehicle load at an instant. The vehicle location data and the vehicle load at any instant is communicated simultaneously to a driver of the vehicle.

According to an embodiment herein, the vehicle load at an instant computed by measuring changes in a vehicle suspension system.

According to an embodiment herein, the changes in the vehicle suspension system is measured by a variation in pressure applied on the load cell in the weight sensing device at an instant.

According to an embodiment herein, the weight sensing device further comprises a device case, a lid attached to the device case, the load cell unit arranged inside the device case and a circuit board for measuring a pressure applied on the load cell and converting the applied pressure level into a resistance value.

According to an embodiment herein, the weight sensing device is connected to the voltage conversion unit through a wired connection.

According to an embodiment herein, the weight sensing device is connected to the AVL system through a wired connection or wireless connection.

According to an embodiment herein, the AVL system is provided in a driver cabin in the vehicle.

According to an embodiment herein, the AVL is provided with a monitor to display the vehicle load and the vehicle location data simultaneously.

According to an embodiment herein, the central computer receives the voltage data from the voltage conversion unit through the AVL system to calculate the vehicle load, at an instant using a pre-calibrated chart.

According to an embodiment herein, the AVL system communicates with navigation satellite to receive a current location of the vehicle.

According to an embodiment herein, the central computer receives the vehicle location data and the voltage data from the AVL system to monitor a vehicle location and the vehicle load at any instant.

According to an embodiment herein, the central computer forwards the calculated vehicle load data to the AVL for display on the monitor.

According to an embodiment herein, the central computer stores the vehicle load data, the vehicle location data and speed of the vehicle at any instant in a memory along with a time stamp.

According to an embodiment herein, the central computer receives a position data, and wherein the position data includes a longitude, latitude and altitude of the vehicle at any instant, a speed of the vehicle, bearing data and a time data from the AVL.

According to an embodiment herein, the central computer validates the received data. According to an embodiment herein, the automatic vehicle load monitoring system and navigation monitoring system further comprises a ball bearing placed on the compression spring.

According to an embodiment herein, the vehicle load is calculated based on a variation in a distance of chassis with respect a load on the vehicle.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates system architecture for measuring changes in the vehicle suspension system for monitoring changes of vehicle loading weight in various local and time situations and also checking driver's attitude toward road surface roughness, according to an embodiment herein.

FIG. 2 illustrates a block diagram of a system for measuring changes in the vehicle suspension system for monitoring changes of vehicle loading weight data in various local and time situations and displaying the data to the users, according to an embodiment herein.

FIG. 3 illustrates a weight sensor installed on the back chassis and axle of a vehicle, according to an embodiment herein.

FIG. 4A and FIG. 4B jointly illustrates a system for measuring changes in the vehicle suspension system for monitoring changes of vehicle loading weight data in various local and time situations by installing a weight sensor on the back chassis and axle of a vehicle, according to an embodiment herein.

FIG. 5A and FIG. 5B jointly illustrates a sectional view of the back chassis and axle of a vehicle installed with a weight sensor for measuring changes in the vehicle suspension system for monitoring changes of vehicle loading weight data in various local and time situations, according to an embodiment herein.

FIG. 6 illustrates an isometric view of the weight sensor installed on the back chassis and axle of a vehicle for measuring changes in the vehicle suspension system for monitoring changes of vehicle loading weight data in various local and time situations, according to an embodiment herein.

FIG. 7 is a flowchart illustrating a method for measuring changes in the vehicle suspension system for monitoring changes of vehicle loading weight data in various local and time situations by installing a weight sensor on the back chassis and axle of a vehicle, according to an embodiment herein.

FIG. 8 is a report illustrating, continuous and point display of vehicles' weight and position generated through a data saved in the database of the central server, according to an embodiment herein.

FIG. 9 illustrates a report of sensor function toward geographical region, according to an embodiment herein.

FIG. 10 illustrates a report generated for assisting driver of the vehicle, according to an embodiment herein.

FIG. 11 illustrates a circuit diagram for weight sensing using a load cell, according to an embodiment herein.

Although the specific features of the present invention are shown in some drawings and not in others. This is done for convenience only as each feature may he combined with any or all of the other features in accordance with the present invention.

### DETAILED DESCRIPTION OF THE EMBODIMENTS

In the following detailed description, a reference is made to the accompanying drawings that form a part hereof, and in which the specific embodiments that may be practiced is shown b way of illustration. These embodiments are described in sufficient detail to enable those skilled in the art to practice the embodiments and it is to be understood that the logical, mechanical and other changes may be made without departing from the scope of the embodiments. The following detailed description is therefore not to he taken in a limiting sense.

The various embodiments herein provide an automatic vehicle load monitoring system and navigation monitoring system. The system comprises a weight sensing device attached to a base of a vehicle, and wherein the weight sensing, device is a load cell, a compression spring attached to the weight sensing device and to a suspension spring of the vehicle, a voltage conversion unit attached to the weight sensing device to convert an output resistance of the load cell into a voltage, an automatic vehicle location (AVL) system connected to the voltage conversion unit to receive the output voltage from the voltage conversion unit and a central server connected to the AVL to receive a vehicle location data and a voltage data for computing a vehicle load at an instant. The vehicle location data and the vehicle load at any instant is communicated simultaneously to a driver of the vehicle.

According to an embodiment herein, the vehicle load at an instant is computed by measuring changes in to vehicle suspension system.

According to an embodiment herein, the changes in the vehicle suspension system is measured by a variation in pressure applied on the load cell in the weight sensing device at an instant.

According to an embodiment herein, the weight sensing device further comprises a device case, a lid attached to the device case, the load cell unit arranged inside the device case and a circuit board for measuring a pressure applied on the load cell and converting the applied pressure level into a resistance value.

According to an embodiment herein, the weight sensing device is connected to the voltage conversion unit through a wired connection.

According to an embodiment herein, the weight sensing,device is connected to the AVL system through a wired connection or wireless connection.

According to an embodiment herein, the AVL system is provided in a driver cabin in the vehicle.

According to an embodiment herein, the AVL is provided with a monitor to display the vehicle load and the vehicle location data simultaneously.

According to an embodiment herein, the central computer receives the voltage data from the voltage conversion unit through the AVL system to calculate the vehicle load at an instant using a pre-calibrated chart.

According to an embodiment herein, the AVL system communicates with a navigation satellite to receive a current location of the vehicle.

According to an embodiment herein, the central computer receives the vehicle location data and the voltage data from the AVL system to monitor a vehicle location and the vehicle load at any instant.

According to an embodiment herein, the central computer forwards the calculated vehicle load data to the AVL fir display on the monitor.

According to an embodiment herein, the central computer stores the vehicle load data, the vehicle location data and speed of the vehicle at any instant in a memory along with a time stamp.

According to an embodiment herein, the central computer receives a position data, and wherein the position data includes a longitude, latitude and altitude of the vehicle at any instant, a speed of the vehicle, bearing data and a time data from the AVL.

According to an embodiment herein, the central computer validates the received data. According to an embodiment herein, the automatic vehicle load monitoring system and navigation monitoring system further comprises a ball bearing placed on the compression spring.

According to an embodiment herein, the vehicle load is calculated based on a variation in a distance of chassis with respect a load on the vehicle.

According to an embodiments herein, a system and method is provided for measuring changes of vehicle suspension system in order to monitor changes of vehicle loading weight in various local and time situations and also checking driver's attitude toward road surface roughness. For this purpose, this system consists of two main parts: hardware and software. Hardware part is in control of measuring changes of suspension system and processing these data in order to gain vehicle loading weight. Concluded weight could be displayed to the driver on the LCD in vehicle cabin, or together with received data from positioning module (received from positioning satellites) including speed and position of vehicle and time in the form of a package is saved offline on a memory or is sent via a wireless module to server software. All these data is parsed in server software and saved in position database, so that various reports required for driver and vehicle function and operation is generated by compounding data related to weight, position, speed and time.

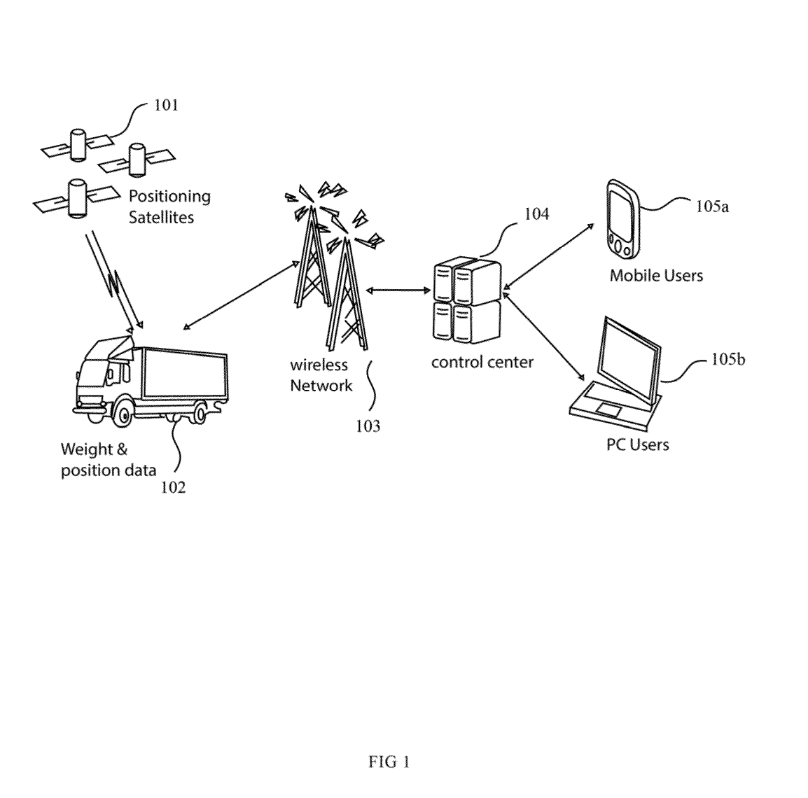

FIG. 1 illustrates system architecture for measuring changes in the vehicle suspension system for monitoring changes of vehicle loading weight in various local and time situations and also checking driver's attitude toward road surface roughness, according to an embodiment herein. The system comprises at-least three positioning satellites 101, one or more load carrying vehicles 102 adopted with a system for measuring changes of suspension system and processing the data in order to gain vehicle loading weight, a central server 104 for storing position and vehicle 102 load weight and wireless communication network 103 for sending position and vehicle 102 load weight from the vehicle 102 to the central server 104. All the data is parsed in the central server 104 and saved in a position database of the central server 104, so that various reports required for driver and vehicle 102 functions and operation is generated by compounding data related to weight, position, and time. The generated reports are further shared with the user's mobile 105a devices and user system (preferably a personal computer of the administrator) 105b through cellular communication network.

According to an embodiment herein, the measured changes of suspension and the vehicle 102 loading weight data are displayed to the driver on the LCD adopted in the vehicle 102 cabin. Further, the measured changes of suspension, vehicle 102 loading weight data and data received from positioning module (received from positioning satellites 101) including speed and position of the vehicle 102 and the time are together saved offline in the form of a package is in a memory adopted in the vehicle 102 system.

According to an embodiment herein, the measured changes of suspension, vehicle 102 loading, weight data and data received from positioning module (received from positioning satellites 101) including speed and position of the vehicle 102 and the time are together sent in the form of a package via wireless communication network 103 to the central server 104.

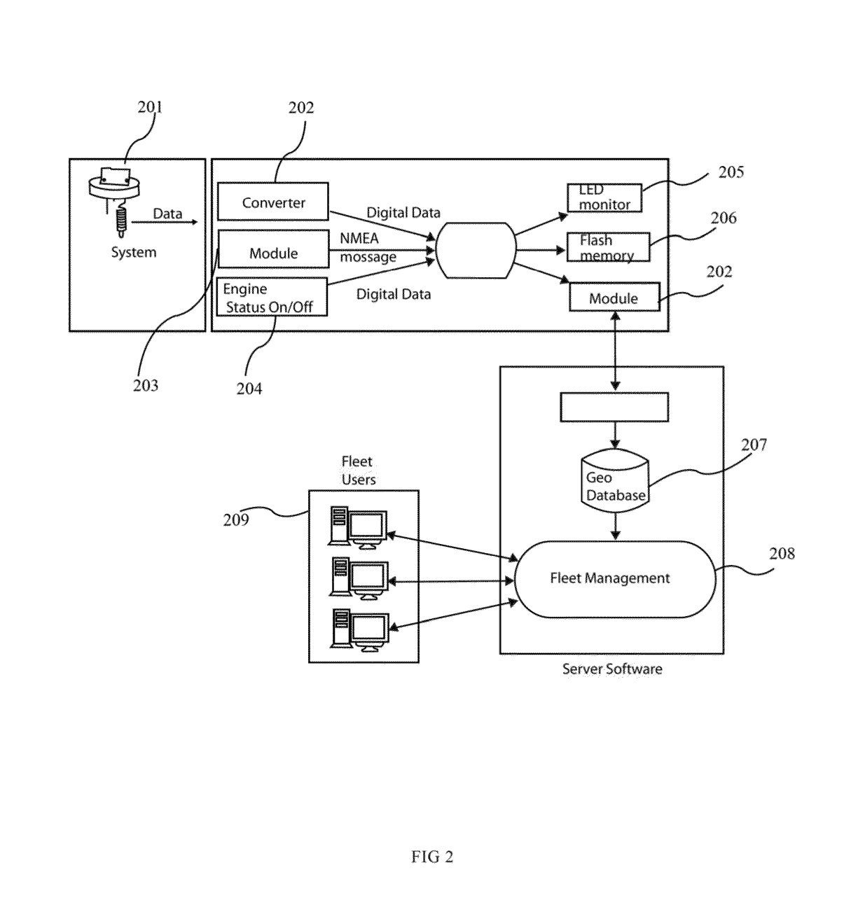

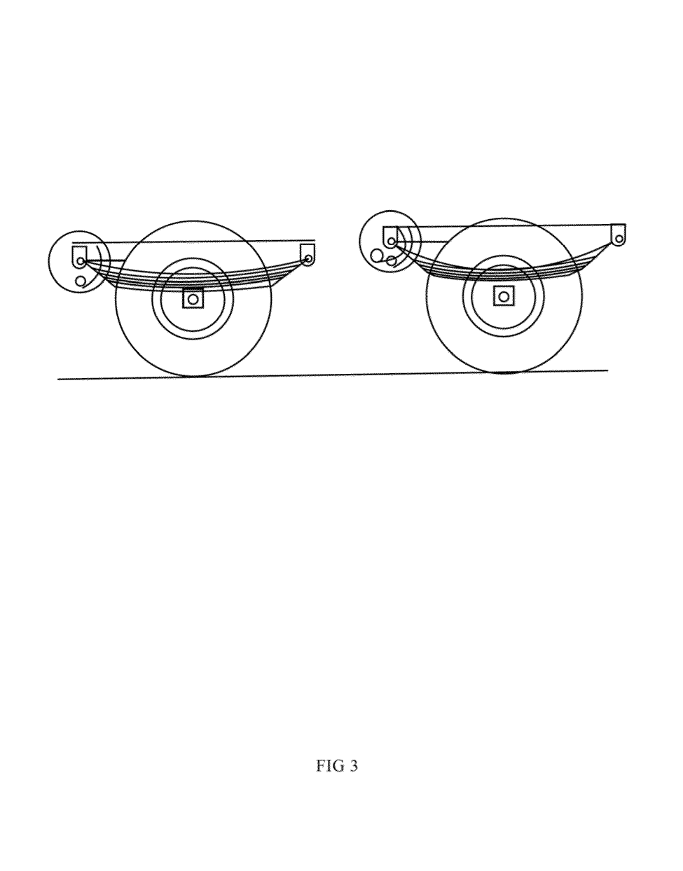

FIG. 2 illustrates a block diagram of a system for measuring changes in the vehicle suspension system for monitoring changes of vehicle loading weight data in various local and time situations and displaying the data to the users, according to an embodiment herein. The system comprises a weight sensor 201 installed on the back chassis and axle of a vehicle. The weight sensor 201 measures the load/weight of the vehicle. The load/weight data obtained from the weight sensor 201 i.e. “analog output sensor” shows the incoming, pressure on the spring of the sensor, resulted from the distance changes from the suspension system of the vehicle. The load/weight data obtained from the weight sensor 201 is transformed to the digital data by an Analog-to-Digital 202 circuit. The system further comprises a microcontroller (Central processor) 205 for processing data received from various modules 203 and sending or displaying the data to the users 210. The microcontroller 205 receives data from the weight sensor 201 installed in the vehicle, data from the positioning satellites and data from a dynamo of the vehicle.

According to an embodiment herein, the data received from the weight sensor 201 comprises data obtained from the spring (i.e. data obtained when load compress on the spring of the vehicle). The system of the embodiment herein calculates vehicle loading weight according to the data applied previously on the settings in order to calibrate the weight.

According to an embodiment herein, the data received from the positioning satellites comprises longitude, latitude and altitude of the vehicle along with the speed, bearing and time. The microcontroller 205 controls the validation of received data after processing posted string from the positioning satellites. The positioning satellites are any of the GPS, GLONASS, GALILEO or other positioning modules 203.

According to an embodiment herein, the data received from the dynamo of the vehicle comprises status of turn ON/shut OFF 204 of the vehicle which is digital in nature.

According to an embodiment herein, the positioning data are checked at regular intervals such as every minute and are considered to device configurations. These configurations are done upon differences on at-least three parameters such as but not limited to: time, angle and distance. For example consider an example wherein if time change: 30 seconds, angle change: 20 degree and distance change: 500 meters are defined for a device, then the device analyses positioning data every one second and checks differences of time, angle and distance with previous data received. If each of these differences exceeds specified data in configurations, then new data together with obtained loading weight and status of vehicle engine are packed in a data packet. The packed data are further sent to three different outputs according to applied settings on the device.

According to an embodiment herein, the system for measuring changes in the vehicle suspension system for monitoring changes of vehicle loading weight data in various local and time situations and displaying the data to the users further comprises a LCD screen 206, a flash memory 207 and a wireless network for sending position and vehicle load weight from the vehicle to the central server.

According to an embodiment herein, the LCD screen 206 is provided in the driver's cabin of the vehicle. The LCD screen 206 displays vehicle loading weight.

According to an embodiment herein, the flash memory 207 saves the measured change in the vehicle suspension system i.e. vehicle loading weight data in various local and time situations, so that at specific time intervals, flash memory data is sent to central server manually.

According to an embodiment herein, the received data i.e. measured change in the vehicle suspension system is sent via wireless communication networks such as but not limited to GPRS, 3G, Local wireless, dedicated wireless network, other wireless networks to the central server.

According to an embodiment herein, the received data is stored in the database 208 at the server and fleet management 209 manages the data transfer between server and users 210.

FIG. 3 illustrates a weight sensor installed on the back chassis and axle of a vehicle, according to an embodiment herein. With respect to FIG. 3, the weight sensor is installed on the back chassis and axle of a vehicle. The weight sensor measures the load/weight of the vehicle. The load/weight data obtained from the weight sensor i.e. “analog output sensor ” shows the incoming pressure on the spring, of the sensor, resulted from the distance changes from the suspension system of the vehicle. The load/weight data obtained from the weight sensor is transformed to the digital data by an Analog-to-Digital circuit before sending central server.

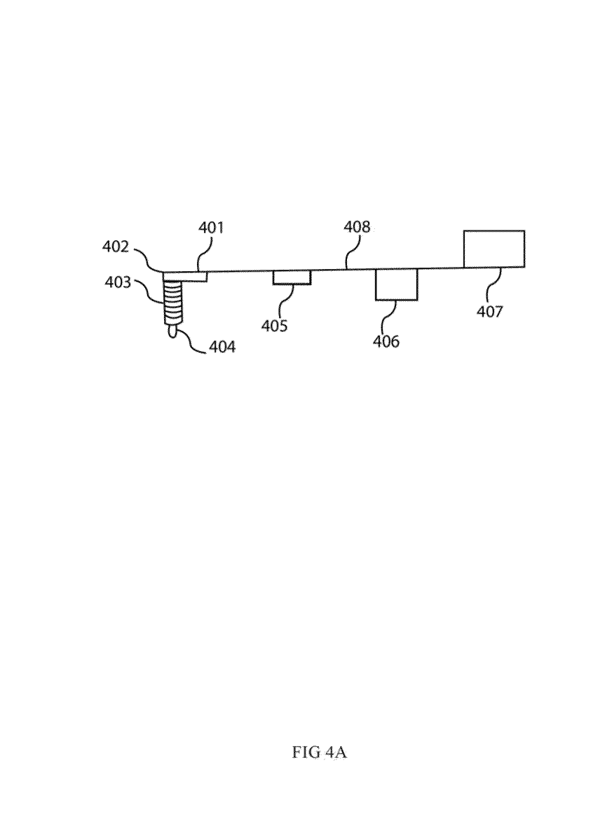

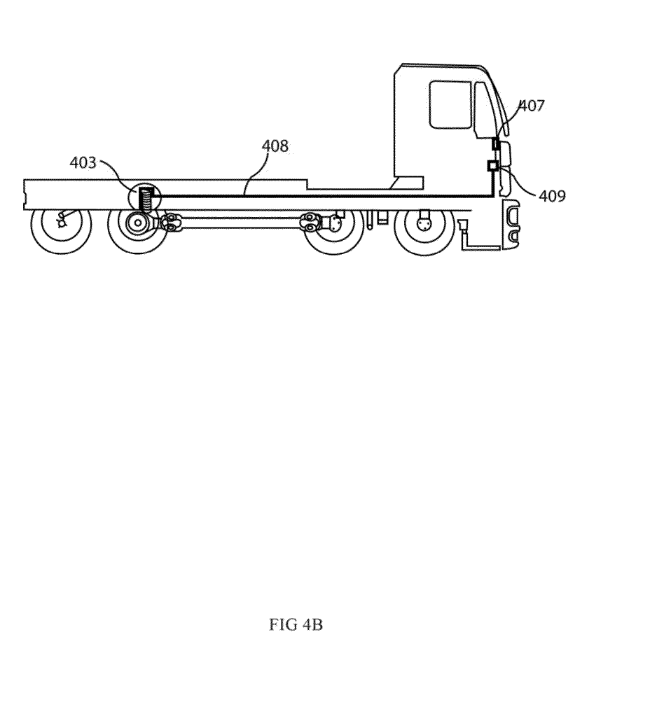

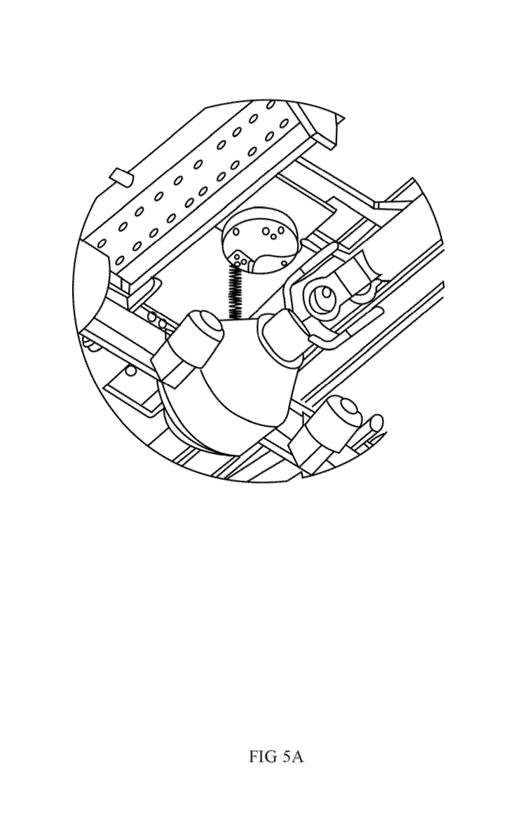

FIG. 4A and FIG. 4B jointly illustrates a system for measuring changes in the vehicle suspension system for monitoring changes of vehicle loading weight data in various local and time situations by installing a weight sensor 402 on the back chassis and axle of a vehicle, according to an embodiment herein. The system comprises a base 401 of the weight sensor 402, a weight sensor 402 capable of weighing up to 20 Kilograms, a spring 403 capable of increasing, pressure up to 20 Kilograms, a ball bearing 404 placed on the spring, a device that converts the system's resistance to 1 to 10 volt 405, a AVL 406, a central computer 407 that calculates the voltage and changes it to a weight proportionate with the weight of the vehicle, a communication cable 408 (a medium to transfer data) and a data transferring system 410 that provides communication between computer 407 and sensor 402. With respect to FIG. 4A and FIG. 4B, the weight sensor (20 kilograms) 402 is attached to the base 401 of the vehicle from one side and to the spring 403 valid for 20 kilograms from the other side. The other side of the spring 403 is placed on the flat spring of the vehicle. When the weight of the vehicle increases, the spring 403 is jammed and it produces a power towards the weight sensor 402 and changes the output resistance. The pivot in the device changes the sensor resistance into voltage 405 in a way that the pivot shows I voltage if there is no load on the chassis and it shows 10 if there is the maximum weight on the chassis This voltage is set on the AVL 406 and it sends to the central computer 407 via wireless communication network such as GPRS, 3G, Local wireless, dedicated wireless network, other wireless networks to the central server. The central server estimates the weight according to a calibration chart.

According to an embodiment herein, the central server estimates the weight according to the calibration chart as shown below. In calibration, the system is able to he set on vehicles with different spring 403 structures. The discharge voltage is recorded according to the weight variance. In order to weigh the vehicle temporarily, a water tank is placed on the chassis. Further, the water tank is connected to a meter for determining the amount of water entered into the tank every minute. Below shows the result for a vehicle with maximum load weight of 500 kilograms:

| | Load | |
|---|---|---|
| | weight(liter | |
| | of entered | Output |
| | water) | voltage |
| 1 | 25 | 1 |
| 2 | 50 | 1.2 |
| 3 | 75 | 1.4 |
| 4 | 100 | 1.58 |
| 5 | 125 | 1.69 |
| 6 | 150 | 1.75 |
| 7 | 175 | 1.9 |
| 8 | 200 | 2 |
| 9 | 225 | 2.2 |
| 10 | 250 | 2.3 |
| 11 | 275 | 2.45 |
| 12 | 300 | 2.57 |
| 13 | 325 | 2.7 |
| 14 | 350 | 2.8 |
| 15 | 375 | 2.95 |
| 16 | 400 | 3.1 |
| 17 | 425 | 3.2 |
| 18 | 450 | 3.3 |
| 19 | 475 | 3.4 |

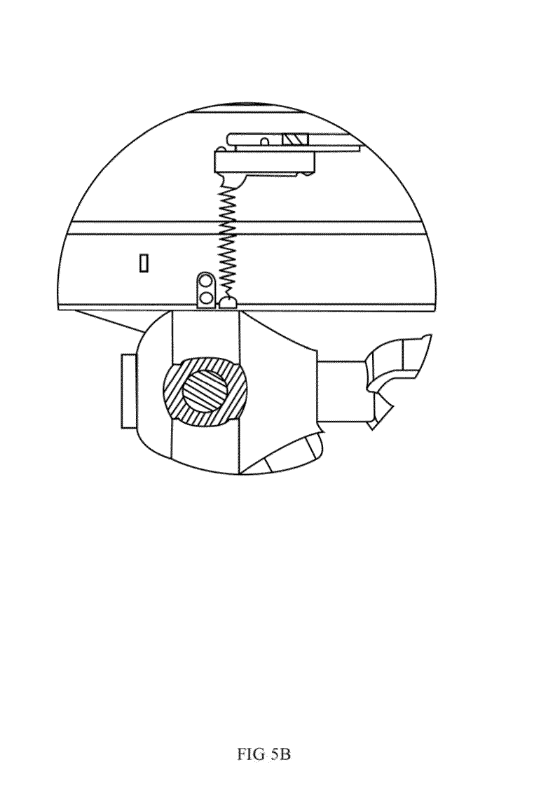

FIG. 5A and FIG. 5B jointly illustrates a sectional view of the back chassis and axle of a vehicle installed with a weight sensor for measuring changes in the vehicle suspension system for monitoring changes of vehicle loading weight data in various local and time situations, according to an embodiment herein. With respect to FIG. 5A and FIG. 5B, the weight sensor is installed on the back chassis and axle of a vehicle. The weight sensor measures the load/weight of the vehicle. The load/weight data obtained from the weight sensor i.e. “analog output sensor” shows the incoming pressure on the spring of the sensor, resulted from the distance changes from the suspension system of the vehicle. The load/weight data obtained from the weight sensor is transformed to the digital data by an Analog-to-Digital circuit before sending central server. The central server estimates the weight according to a calibration chart.

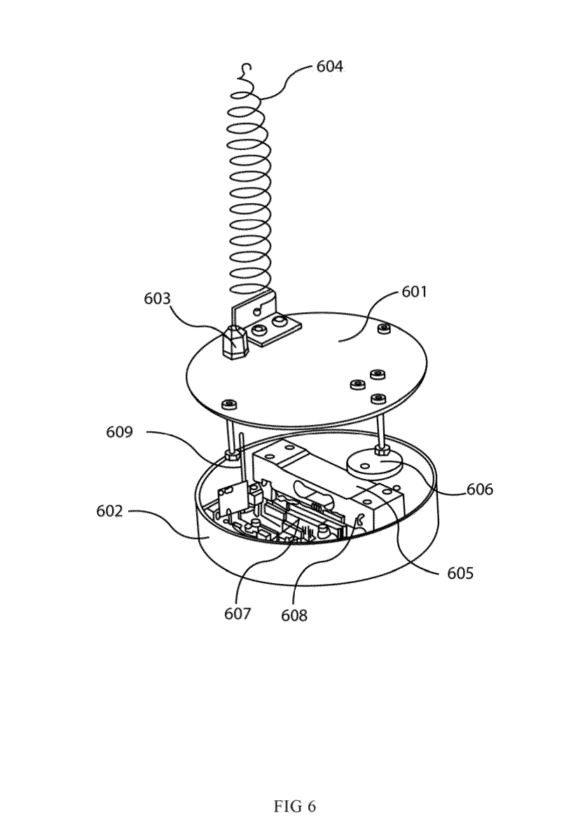

FIG. 6 illustrates an isometric view of the weight sensor installed on the back chassis and axle of a vehicle for measuring changes in the vehicle suspension system for monitoring changes of vehicle loading weight data in various local and time situations, according to an embodiment herein. The system comprises a system cap 601, a device case 602, a channel/port for passing wire from sensor to data processing system 603, a spring 604, a Load cell 605, a spacer 606, a board 608, a data transfer cable 609 from load cell to circuit, a data transferring cable from circuit to data transferring system on drivers cabin, a data transferring system and a monitor or LCD screen in the driver's cabin of the vehicle. As regards forcing power in any way on vehicle chassis cause to changes in the vehicle suspension system and changes in suspension system of vehicle leads to change of height between the chassis and axle of the vehicle, therefore, measuring these changes leads to the calculating vehicle loading weight. When vehicle loading weight changes, the distance between the vehicle chassis and the axle changes. This leads to change of extension of sensor's spring.

According to an embodiment herein, a method for defining linear equations of calibration system is provided. In order to determine unknown weights, some loads with specific weights (known value) are exerted to the vehicle's chassis. In each loading, the output voltage is recorded. In this way, a table is constructed including each specific weight with its corresponding voltage. So for each unknown amount of weight, there is a voltage which is concluded via interpolation of gained voltages, and then the desired (unknown) amount of weight is concluded. It is clear then that in time of loading, it's better to load distributedly, so that the error in calculating the weight is reduced. The number of loadings is higher; output of calibration system is closer to the real amount.

According to an embodiment herein, the system comprising weight sensor installed on the back chassis and axle of a vehicle for measuring changes in the vehicle suspension system for monitoring changes of vehicle loading weight data in various local and time situations sends all data packets to a specific port of the central server. The central server IP addresses and port is applied in the system configurations. So, a socket module is implemented on the central server that listen to the server port continually, so all the components in the system discharges all their data raider connecting to the port and data validation. The socket module referred as “socket interface” parses the input data strings and saves them in a database of the central server. The vehicles' database schema and their sent data are as below:

The table describing each field of geodata table is as below:

| | Type of | Title | |
|---|---|---|---|
| Description | Data | in the Table | Row |
| ID and main key of the table | integer | Idgeodata | 1 |
| Time of taking GPS data | integer | Timestamp | 2 |
| Position including geographical | point | Position | 3 |
| longitude and latitude | | | |
| Speed | integer | Speed | 4 |
| Bearing | integer | Bearing | 5 |
| Unique Hardware ID for each device | integer | IMEI | 6 |
| (connecting key to vehicles table) | | | |
| Status of turn on/shut off of the vehicle | boolean | Ignition | γ |
| Vehicle loading weight | float | Weight | λ |
| Passed Time difference from last taken | integer | diff_time | [symbol] |
| data to current data | | | |
| Covered Distance difference | integer | diff_distance | [symbol] |
| from last taken data to current data | | | |

[symbol]

indicates data missing or illegible when filed

A table describing each field of the “devices table” is as below:

| | Type of | Title | |
|---|---|---|---|
| Description | Data | in the Table | Row |
| Unique Hardware ID for each device | integer | IMEI | 1 |
| and main key of the table | | | |
| Vehicle title for displaying in software, | varchar | title | 2 |
| reports and maps | | | |
| Vehicle Plate Number | integer | plate_number | 3 |
| Sim Card No. set on the device that | integer | sim_number | 4 |
| installed on the vehicle | | | |

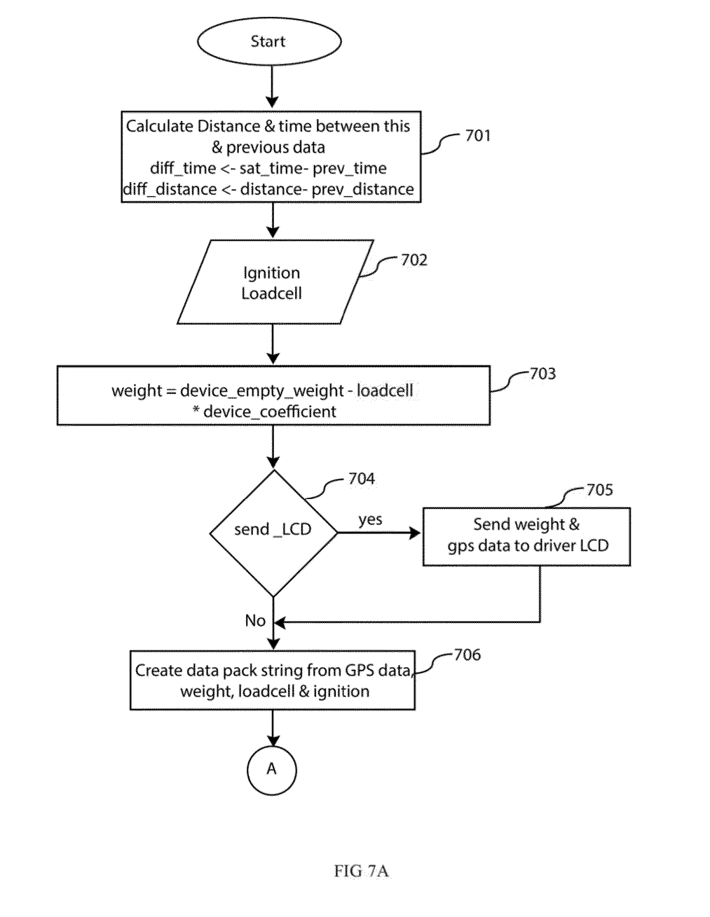

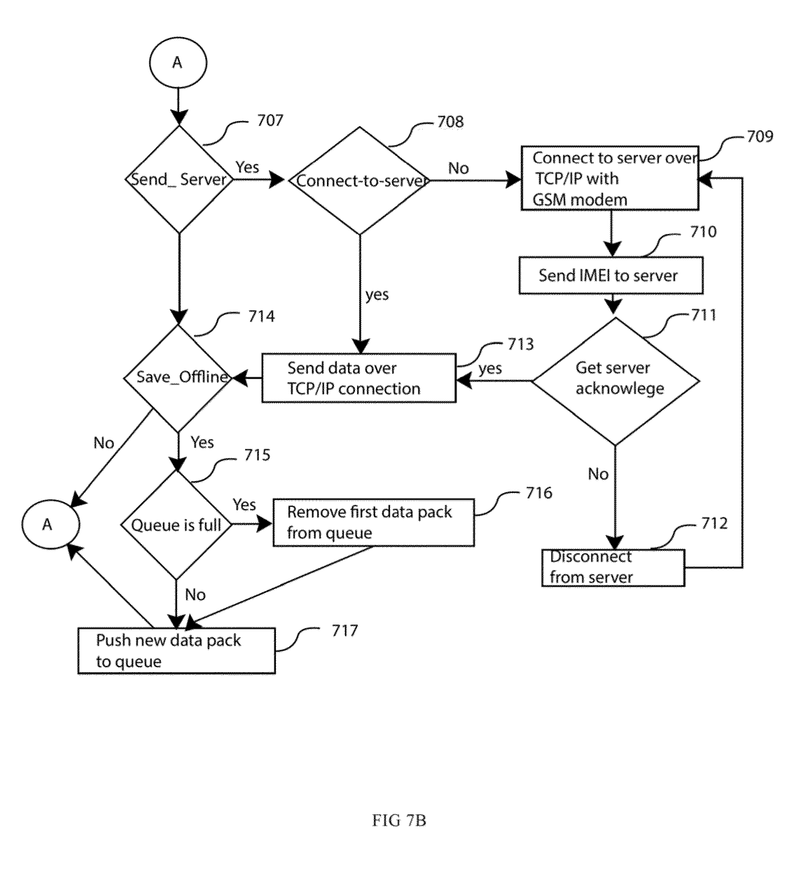

FIG. 7A and FIG. 7B jointly is a flowchart illustrating a method for measuring changes in the vehicle suspension system for monitoring, changes of vehicle loading weight data in various local and time situations by installing a weight sensor on the back chassis and axle of a vehicle, according to an embodiment herein. Using, data received by sensor is used by microcontroller is used to calculate position and speed of the vehicle 701. Also data on the compression of spring 702 is used to calculate load of vehicle by microcontroller and 703. Microcontroller is ready to send the details on speed, location and load on vehicle is sent on to driver's LCD 704 & 705 over wireless communication in form of packets 706. As the microcontroller encounters sent command 707 it gets connected to server 708 over TCP/IP with GSM module 709. The modem sends IMEI number to server 710. After receiving acknowledgement from server 711, data is sent over TCP/IP 713. If acknowledgement is not received the modem is disconnected from server. The sent data is also stored in database 714, where the system checks if queue is full 715. If the queue is full, the system deletes first packet of data in queue 716, and stores the incoming data packet in queue 717.

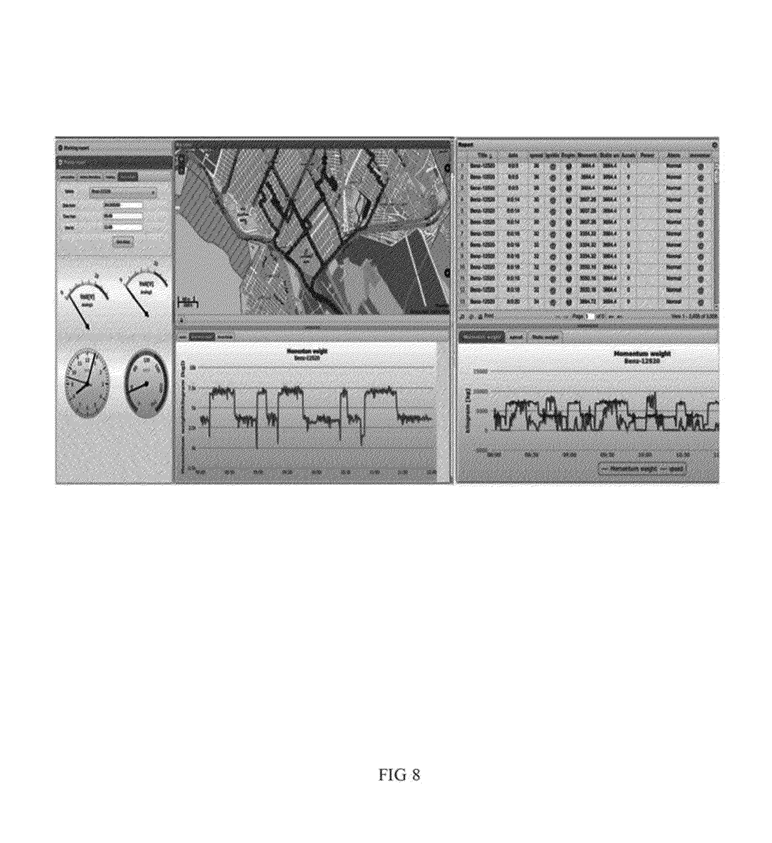

FIG. 8 is a report illustrating continuous and point display of vehicles' weight and position generated through a data saved in the database of the central server, according to an embodiment herein. With respect to FIG. 8, the report comprises the status of the considered vehicle and weight sensor online and point to point on the map, grid and diagram. The report as shown in FIG. 8 is generated upon user request and receives all points in a time interval and displays them on the map. Below of the map, a “line chart” is drawn in one panel and information grid in another panel. In information grid, all descriptive data received from the device such as weight, speed, date of receiving data, departure angle and vehicle's status (turn on/shut off) and all other received data. There are complete integration between the chart, grid and the map items, so that a point is selected by clicking on each of the at-least three parts: map event, chart point or grid row. In one panel, speed chart and received data from weight sensor are drawn, so that comparison between simultaneous changes of the weight sensor and speed of the vehicle is possible and easy.

According to an embodiment herein, the report for total function and operation of the weight sensor in determinable time intervals for carried loading weight is generated from the data saved/stored in the database of the central server. The report informs the user about total function and operation of the weight data such as minimum and maximum speed, standstill and departure, and start-stop time of the vehicle determinable time intervals fir a specific group of vehicles. The report is designed upon the map and also without map. For example: consider a scenario wherein the user request a report for 1000-1500 Kg and 1500-2500 kg; vehicle loading weight in a required time interval for specific group of vehicles. The socket module or a software installed in the central server displays vehicle stopping and driving time, turn on/shut off also maximum-minimum speed along with travelled distance for each vehicle. Pie and column chart report are drawn for numerical data in order to compare between function of various vehicles.

According to an embodiment herein, a detailed report from function of weight sensor data is generated from the data saved/stored in the database of the central server. The aim of designing, the report is to compare general operation and function of fleets in various definable weight ranges for the weight sensor. The report would be designed upon the map and without a map. In map-based reports, the report is taken from one vehicle and following information is displayed for user: start to end time, average, sensor maximum and minimum, average and maximum of speed and passed distance. For example, consider a scenario wherein the user requests for ranges 1000-1500 kg and 1500-2500 kg vehicle loading weight in required time intervals for a specific vehicle. The socket module or a software installed in the central server displays following items to the user: the time that vehicle loading, reaches to 1000 kg (start point), the time that vehicle loading reaches to less than 1000 kg (end time), average of vehicle loading weight, passed distance, average and maximum and minimum of speed, vehicle stopping and driving time, turn on/shut off.

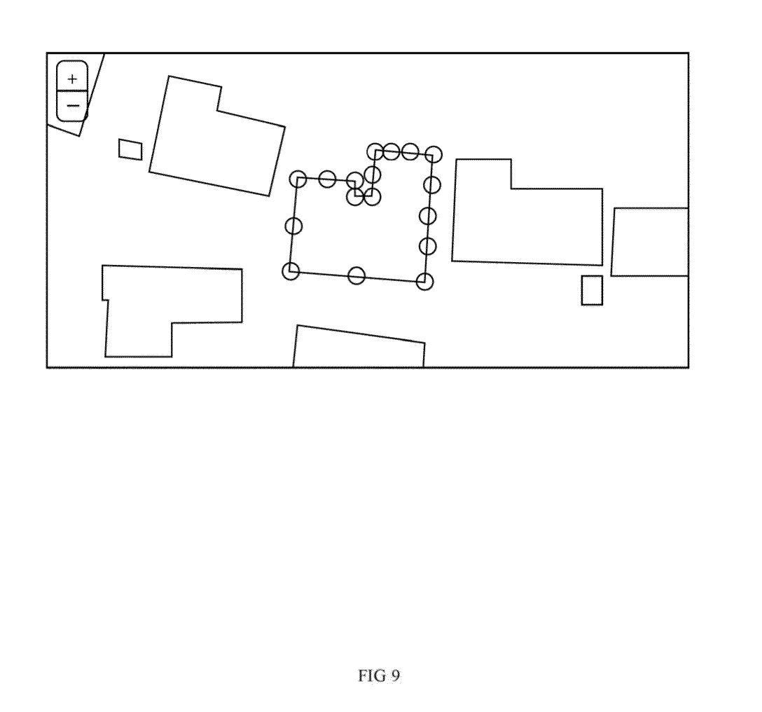

FIG. 9 illustrates a report of sensor function toward geographical region, according to an embodiment herein. With respect to FIG. 9, the user requests in socket module or a software installed in the central server for vehicle function in a regular polygon geographical region and a specific time interval. The socket module or a software installed in the central server display following results: time of entering to region, time of exit from region, presence time of vehicle in region, amount of weight resulted from sensor in time of entering and exiting, average-maximum-minimum of weight amount in presence time of vehicle in the region, passed distance in that time interval as shown in FIG. 9. In order to draw a regular polygon in the socket module or software installed in the central server, one map panel is designed; so that the user draws the desired polygon just by a click on the map and continue the drawing by double click on the map. Then, a form is opened, the user types the name of the desired region, so a specific region by known name is drawn for user, this name will be used later for choosing that region.

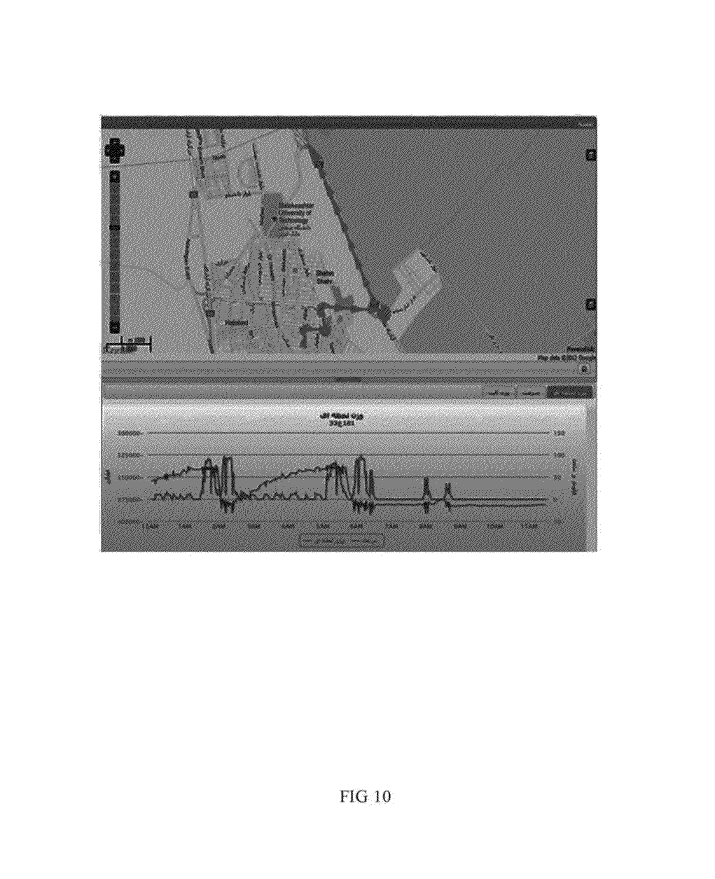

FIG. 10 illustrates a report generated for assisting driver of the vehicle, according to an embodiment herein. The report as shown in FIG. 10 is resulted according to data received from weight sensor (changes of the suspension system of the vehicle) together with speed and geographical data of vehicle (received data from GPS). The report draws a synthetic diagram of speed and weight sensor data on time, in time of sudden change of weight sensor for a constant amount of speed (nonzero) shows the occurrence of tension in the suspension system of the vehicle (due to road roughness and puddles). High speed and intense change show high tension and imprudence of driver in paying attention to vehicle during driving on road roughnesses. Corresponding points of these diagrams with their related drawn points on the map is integrated for both the map and diagram by a unique ID. Therefore, by clicking on tension points of suspension system on the diagram, its corresponding point on the map is detected and is representative of road roughness location and also driver's disobedience. By the report as shown in FIG. 10, road roughness points could be recognized and could he used over time as a spatial data layer consisted of critical points on the road for all groups of vehicles.

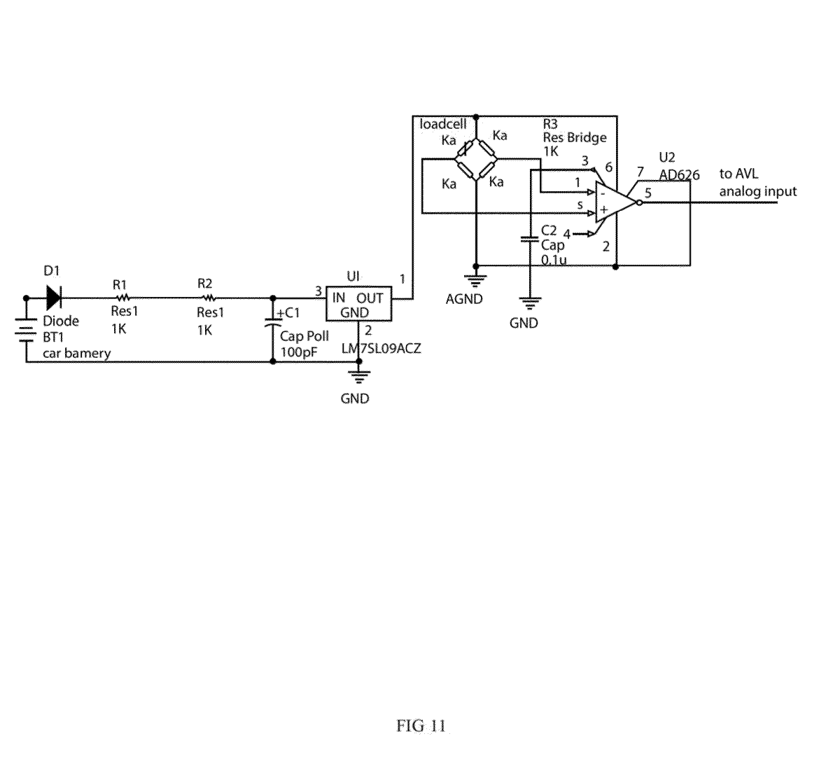

FIG. 11 illustrates a circuit diagram for weight sensing using a load cell, according to an embodiment herein. With respect to FIG. 11, the circuit diagram measures a pressure applied on the load cell and converts the applied pressure level into a resistance value.

The foregoing description of the specific embodiments will so full reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. An automatic vehicle load monitoring system and navigation monitoring system, the system comprising:
a weight sensing device attached to a base of a vehicle, and wherein the weight sensing device is a load cell;
a compression spring attached to the weight sensing device and to a suspension spring of the vehicle;
a voltage conversion unit attached to the weight sensing device to convert an output resistance of the load cell into a voltage;
an automatic vehicle location (AVL) system connected to the voltage conversion unit to receive the output voltage from the voltage conversion unit; and
a central server connected to the AVL to receive a vehicle location data and a voltage data for computing a vehicle load at an instant;
wherein the vehicle location data and the vehicle load at any instant is communicated simultaneously to a driver of the vehicle.

2. The system according to claim 1, wherein the vehicle load at an instant is computed by measuring changes in a vehicle suspension system.

3. The system according to claim 1, wherein the changes in the vehicle suspension system is measured by a variation in pressure applied on the load cell in the weight sensing device at an instant.

4. The system according to claim 1, wherein the weight sensing device comprises:
a device case;
a lid attached to the device case;
the load cell unit arranged inside the device case; and
a circuit board for measuring a pressure applied on the load cell and converting the applied pressure level into a resistance value.

5. The system according to claim 1, wherein the weight sensing device is connected to the voltage conversion unit through a wired connection.

6. The system according to claim 1, wherein the weight sensing device is connected to the AVL system through a wired connection or wireless connection.

7. The system according to claim 1, wherein the AVL system is provided in a driver cabin in the vehicle.

8. The system according to claim 1, wherein the AVL is provided with to monitor to display the vehicle load and the vehicle location data simultaneously.

9. The system according to claim 1, wherein the central computer receives the voltage data from the voltage conversion unit through the AVL system to calculate the vehicle load at an instant using a pre-calibrated chart.

10. The system according to claim 1, wherein the AVL system communicates with a navigation satellite to receive a current location of the vehicle.

11. The system according to claim 1, wherein the central computer receives the vehicle location data and the voltage data from the AVL system to monitor a vehicle location and the vehicle load at any instant.

12. The system according to claim 1, wherein the central computer forwards the calculated vehicle load data to the AVL for display on the monitor.

13. The system according to claim 1, wherein the central computer stores the vehicle load data, the vehicle location data and speed of the vehicle at any instant in a memory along with a time stamp.

14. The system according to claim 1, wherein the central computer receives a position data, and wherein the position data includes a longitude, latitude and altitude of the vehicle at any instant, a speed of the vehicle, bearing data and a time data from the AVL.

15. The system according to claim 1, wherein the central computer validates the received data.

16. The system according to claim 1, further comprises a ball bearing placed on the compression spring.

17. The system according to claim 1, wherein the vehicle load is calculated based on a variation in a distance of chassis with respect a load on the vehicle.
